(19) United States
(12) Patent Application Publication
(10) Pub. No.: US 2011/0250484 A1
(43) Pub. Date: Oct. 13, 2011

(54) Battery Pack and Combination of the Battery Pack and an Electric Device

(75) Inventor: Zhihua Meng, Changzhou (CN)

(73) Assignee: Changzhou Globe Tools Co., Ltd.

(21) Appl. No.: 12/939,163

(22) Filed: Nov. 3, 2010

(30) Foreign Application Priority Data
Apr. 12, 2010 (CN) 201010145919.1

(51) Int. Cl. H01M 2/10; B25F 5/00

(52) U.S. Cl. 429/97; 173/217

(57) ABSTRACT

The present patent application relates to a battery pack for connecting to a cordless power tool to supply power thereto, the battery pack may supply two volumes or more than two volumes of voltage or capacity to the cordless electric device, the battery pack provided with a first connection terminal set which electrically connected to a battery cell set, the first connection terminal set provided with a transmission switch, shift the transmission switch to connect two sets or more than two sets of battery cell sets in series or in parallel so that output two volumes or more than two volumes of voltage or capacity.

### CROSS-REFERENCE TO RELATED APPLICATIONS

This application claims benefits of Chinese patent application no. 201010145919.1 filed on Apr. 12, 2010, the entire content of which is hereby incorporated by reference.

### TECHNICAL FIELD

The present patent application relates to a battery pack, in particular, relates to a battery pack which is able to supply multiple volumes of voltage/capacity.

The present patent application relates to a combination of a battery pack and an electrical device as well, in particular, relates to a combination thereof the battery pack is able to supply two volumes of voltage or more than two volumes of voltage/capacity to the electrical device.

### BACKGROUND

In the recent years, along the development of the material made battery cell, the capacity of the battery cell has been enlarged in a very large extent; the applicable scope of them has also extended from the small power electronic electrical device to the large power electronic electrical device, such as power tools, and so on. In this case, the power tool equipped with this kind of large power battery cell is able to escape the limit of the cable and can be used at any time and everywhere. For enhancing the rate of use, this kind of battery normally equipped with re-chargeable battery pack, such as Nickel-cadmium battery, Nickel-Metal Hydride battery, Lithium-ion battery pack, and so on.

In the normal battery pack available in the market, all the batteries connected together by wires, two terminals remain for outputting one voltage or capacity; it only can supply power to the electric device which require same volume power other than the power tools which required larger or smaller volume power as the voltage or capacity outputted by this kind of battery is not variable, so, the applicable scope of them is limited, it takes inconvenience to the user.

Besides, what normal in the market is that dispose electronic element on the battery pack or on the electric device, the voltage outputted by the battery pack is regulated by the electronic element, so that part of the capacity of the battery pack must be consumed by the electronic element and the usage rate of the battery pack does not reach the maximum extent as the existence of the devices such as electronic element, and the cost of the electric device or battery pack is enhanced in a very large extent.

### SUMMARY

The present patent application supplies a battery pack which can supply multiple volumes of voltage or capacity, furthermore, the cost of design and product is comparatively low.

The present patent application supplies a combination of battery pack and electric device, therein, the battery pack can supply multiple volumes of voltage or capacity to the electric device, furthermore, the cost of design and product is comparatively low.

For realization of one of the foregoing aims, the technical solution of the present patent application comprising:

A battery pack supplies two volumes or more than two volumes of voltage or capacity.

According to another embodiment of the present patent application, the battery pack further comprises two sets or more than two set of battery cell, the two sets or more than two sets of battery cell connected in series or in parallel and two volumes or more than two volumes of voltage or capacity could be outputted therefrom.

According to a further another embodiment of the present patent application, the battery pack provided with a first terminal set which is electrically connected to the battery cell set, the first terminal set provided with a transmission switch, shifting the transmission switch, at least two set of battery cells connected in series or in parallel so as to supply two volumes or more than two volumes of voltage or capacity out.

According to a further another embodiment of the present patent application, the battery pack can be used for connection to a cordless power tool and supply voltage or capacity thereto.

According to further another embodiment of the present patent application, the first terminal set at least including a first positive terminal, a first negative terminal, a first positive terminal′ and a first negative terminal′, when two sets of battery cell or more than two sets of battery cell connected in parallel so as to output voltage or capacity, via shifting a transmission switch, the first positive terminal being electrically connected to the first positive terminal′ and the first negative terminal being electrically connected to the first negative terminal′; when two sets of battery cell or more than two sets of battery cell connected in series so as to output voltage or capacity, via shifting a transmission switch, the first negative terminal being electrically connected to the first positive terminal′ and the first positive terminal being electrically connected to the first negative terminal′.

According to further another embodiment of the present patent application, the transmission switch works electronically or mechanically.

For realization of one of the foregoing aims, the technical solution of the present patent application also could be:

A combination of a battery pack and an electrical device, comprising:

A battery pack, which including two sets or more than two sets of battery cell and a first terminal set that electrically connected to the battery cell sets;

A electrical device, which including a second connection terminal set that responses to the first connection terminal set so that two volumes or more than two volume of voltage or capacity outputted from the battery pack to the electrical device.

Therein, when the working voltage of the electrical device being the voltage of a set of battery pack or being the plus of two sets or more than two sets of battery cell, the second connection terminal set of the electrical device connected to the first connection terminal set of the battery pack so as to connect two sets of battery cell or more than two sets of batteries in parallel; when the working voltage of the electrical device being the plus of the voltage/capacity of two sets or more than two sets of battery cell, the second connection terminal set of the electrical device connected to the connection first terminal set of the battery pack so as to connect two sets of battery cell or more than two sets of batteries in series.

According to further another embodiment of the present patent application, the first connection terminal set at least including a first positive terminal, a first negative terminal, a first positive terminal′ and a first negative terminal′, the second connection terminal set including a second positive terminal and a second negative terminal which are correspondingly connected to the first positive terminal and the first negative terminal, and a second positive terminal′ and a second negative terminal′ which are correspondingly connected to the first positive terminal′ and the first negative terminal′

According to further another embodiment of the present patent application, the electrical device is a cordless power tool.

According to further another embodiment of the present patent application, when the working voltage of the electrical device being the voltage of a set of battery cell, the second positive terminal electrically connected to the second positive terminal′, the second negative terminal electrically connected to the second negative terminal′.

According to further another embodiment of the present patent application, when the working voltage of the electrical device being the plus of two sets of battery cell or the plus of more than two sets of battery cell, the second negative terminal electrically connected to the second positive terminal′, the second positive terminal electrically connected to the second negative terminal′.

Technical advantages of the present patent application are as follows: comparison with the state of art, without additionally adding any electronic element so that the unnecessary consuming of power is avoided; moreover, the battery pack of the present patent application can supply power to the electric devices which require different voltage so that it can be used for supplying power to the electric devices which are with different rated voltage; the university of is very high so that the manufacturing cost reduced.

### BRIEF DESCRIPTION OF THE DRAWINGS

FIG. 1 is a circuit diagram of one preferred embodiment of the present patent application which composed two sets of battery cell.

FIG. 2 is a circuit diagram of another preferred embodiment of the present patent application which composed three sets of battery cell.

FIG. 3 and FIG. 4 are circuit diagrams of further another preferred embodiment of the present patent application which composed two sets of battery cell.

FIG. 5 and FIG. 6 are circuit diagrams of further another preferred embodiment of the present patent application which composed three sets of battery cell.

### DETAILED DESCRIPTION

The present patent application will be described in detail by reference the drawings and the preferred embodiments. All drawings are simplified illustration diagrams, only serve as references of the basic structure of the present patent application in schematic way, so, they only illustrate the composition which is relevant to the present patent application.

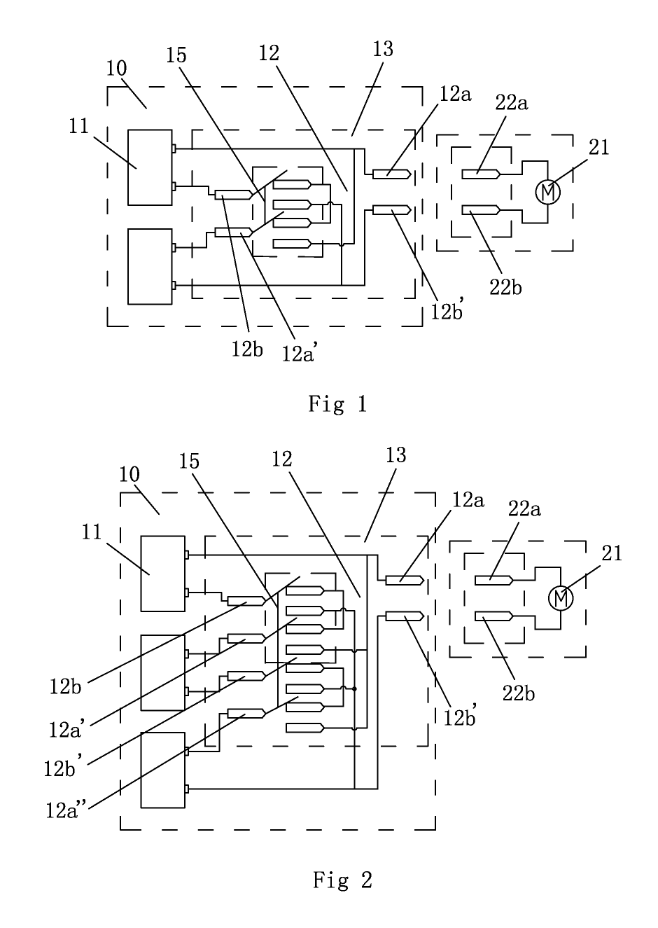

FIG. 1 is a circuit diagram of one preferred embodiment of the present patent application which composed two sets of battery cell. What easy understood to those skilled in the art are as follows, battery pack 10, power tool 20, the battery pack 10 comprises two sets of battery cell set 11, a first connection terminal set 12 which is correspondingly electrically connected to the battery cell set 11, the power tool 20 comprises a motor 21, a second connection terminal set 22 which is correspondingly electrically connected to the first connection terminal set 12. The first connection terminal set 12 provided with a transmission switch 15.

In this embodiment, the battery cell set 11 is composed by 5 battery cells, the rated voltage of each battery cell is 3.8V therein and the rated voltage of each battery cell set is 19V, of course, in other embodiments, the type of the battery cell or the number of the battery cells in the composition could be vary, depending on the different working conditions and could be decided according to the concrete situation.

In the embodiment, the battery pack 10 further provided with a first interface 13, the first connection terminal set 12 comprises a first positive terminal 12a, a first negative terminal 12b, a first positive terminal′ 12a′ and a first negative terminal′ 12b′, the first positive terminal 12a and the first negative terminal 12b located at the first interface 13, the first positive terminal′ 12a′ and the first negative terminal′ 12b′ also located at the first interface 13, the second connection terminal set 22 comprises a second positive terminal 22a and a second negative terminal 22b. Herein, shift the transmission switch 15 to connect two sets of battery cell set 11 in parallel and output voltage to the first positive terminal 12a and the first negative terminal′ 12b′ so that the outputting voltage between the first positive terminal 12a and the first negative terminal′ 12b′ is 19V; shift the transmission switch 15 to connect two sets of battery cell set 11 in series and output voltage to the first positive terminal 12a and the first negative terminal′ 12b′ so that the outputting voltage between the first positive terminal 12a and the first negative terminal′ 12b′ is 38V.

Therein, when the required voltage of the motor 21 is 20V, firstly, shifting the transmission switch 15, electrically connect the first positive terminal 12a to the first positive terminal′ 12a′ and electrically connect the first negative terminal 12b to the first negative terminal′ 12b′, and then, connect the power tool 20 into the first interface 13 of the battery pack 10, at this moment, the first positive terminal 12a connected to the second positive terminal 22a, the first negative terminal′ 12b′ connected to the second negative terminal 22b, so that the voltage outputted from battery pack 10 to the power tool 20 is 19V and drives the motor 21 to run.

When the required voltage of the motor 21 is 40V, firstly, shifting the transmission switch 15, electrically connect the first negative terminal 12b to the first positive terminal′ 12a′, and then, connect the power tool 20 into the first interface 13 of the battery pack 10, at this moment, the first positive terminal 12a connected to the second positive terminal 22a, the first negative terminal′ 12b′ connected to the second negative terminal 22b, so that the voltage outputted from battery pack 10 to the power tool 20 is 38V and drives the motor 21 to run.

FIG. 2 is a circuit diagram of another preferred embodiment of the present patent application which composed three sets of battery.

In this second embodiment, the battery pack 10 provided with a first interface 13, the first connection terminal set 12 comprises a first positive terminal 12a, a first negative terminal 12b, a first positive terminal′ 12a′, a first negative terminal′ 12b′, a first positive terminal″ 12a″ and a first negative terminal″ 12b″. The first positive terminal 12a, the first negative terminal 12b, the first positive terminal′ 12a′, the first negative terminal′ 12b′, the first positive terminal″ 12a″ and the first negative terminal″ 12b″ located at the first interface 13, the second connection terminal set 22 comprises a second positive terminal 22a and a second negative terminal 22b. Therein, three battery cell sets 11 connected in parallel and output a voltage to the first positive terminal 12a and the first negative terminal″ 12b″, so that the rated outputting voltage between the first positive terminal 12a and the first negative terminal″ 12b″ is 19V; three battery cell sets 11 connected in series and outputs voltage to the first positive terminal 12a and the first negative terminal″ 12b″, so that the rated outputting voltage between the first positive terminal 12a and the first negative terminal″ 12b″ is 57V.

Therein, when the required voltage of the motor 21 is 20V, firstly, shifting the transmission switch 15, electrically connect the first positive terminal 12a, the first positive terminal′ 12a′ and the first positive terminal″ 12a″ together, and, electrically connect the first negative terminal 12b, the first negative terminal′ 12b′ and the first negative terminal″ 12b″ together, and then, connect the power tool 20 into the first interface 13 of the battery pack 10, at this moment, the first positive terminal 12a connected to the second positive terminal 22a, the first negative terminal″ 12b″ connected to the second negative terminal 22b, so that the voltage outputted from battery pack 10 to the power tool 20 is 19V and drives the motor 21 to run.

Therein, when the required voltage of the motor 21 is 60V, firstly, shifting the transmission switch 15, electrically connect the first negative terminal 12b to the first positive terminal′ 12a′, electrically connect the first negative terminal 12b to the first positive terminal″ 12a″, and then, connect the power tool 20 into the first interface 13 of the battery pack 10, at this moment, the first positive terminal 12a connected to the second positive terminal 22a, the first negative terminal″ 12b″ connected to the second negative terminal 22b, so that the voltage outputted from battery pack 10 to the power tool 20 is 57V and drives the motor 21 to run.

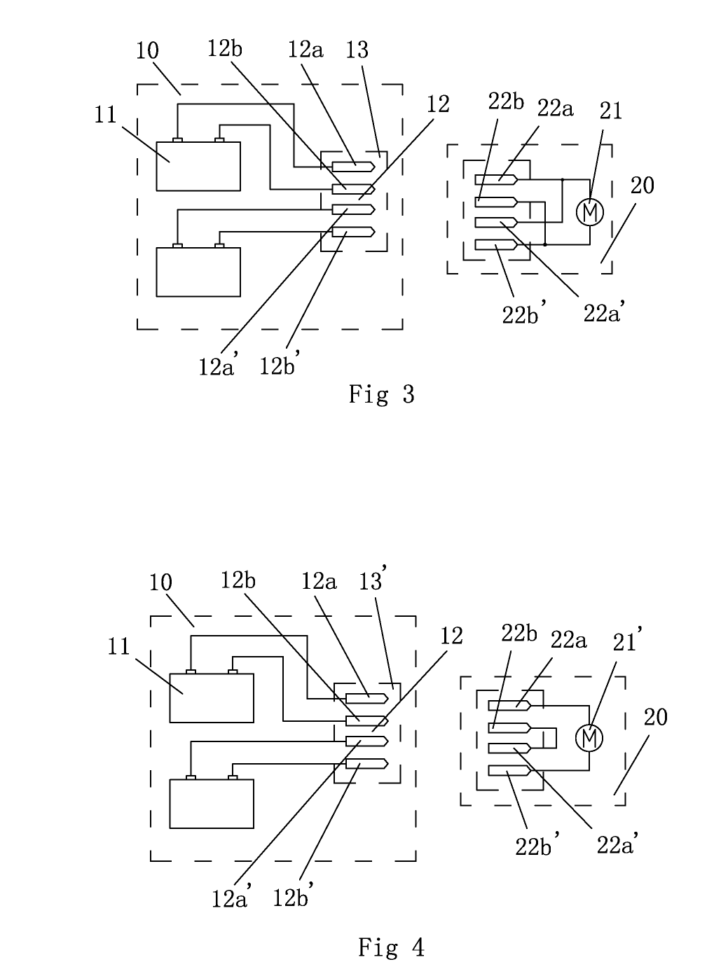

FIG. 3 and FIG. 4 are circuit diagrams of further other preferred embodiments of the present patent application which composed two sets of battery cell. The battery pack 10 provided with a first interface 13 as well, the first connection terminal set 12 comprises a first positive terminal 12a, a first negative terminal 12b, a first positive terminal′ 12a′, a first negative terminal′ 12b′, the first positive terminal 12a, the first negative terminal 12b, the first positive terminal′ 12a′, the first negative terminal′ 12b′ located at the first interface 13, the second connection terminal set 22 comprises a second positive terminal 22a and a second negative terminal 22b which correspondingly electrically connected to the first positive terminal 12a and the first negative terminal 12b, and, a second positive terminal′ 22a′ and a second negative terminal′ 22b′ which electrically connected to the first positive terminal′ 12a′ and the first negative terminal′ 12b′. Therein, the second positive terminal 22a electrically connected to the second positive terminal′ 22a′, the second negative terminal 22b electrically connected to the second negative terminal′ 22b′, so that two sets of battery cell 11 are connected in parallel, and then the rated voltage which outputted from the battery pack to the motor 21 is 19V; the second negative terminal 22b electrically connected to the second positive terminal′ 22a′, the second positive terminal 22a electrically connected to the second negative terminal′ 22b′, so that two sets of battery cell 11 are connected in series, and then the rated voltage which outputted from the battery pack 10 to the motor 21 is 38V.

Reference to FIG. 3, when the required voltage of the motor 21 is 20V, connect the power tool 20 into the first interface 13 of the battery pack 10, at this moment, the first positive terminal 12a connected to the second positive terminal 22a, the first negative terminal 12b connected to the second negative terminal 22b, the first positive terminal′ 12a′ connected to the second positive terminal′ 22a′, the first negative terminal′ 12b′ connected to the second negative terminal′ 22b′, the second positive terminal 22a connected to the second positive terminal′ 22a′, the second negative terminal 22b connected to the second negative terminal′ 22b′, so that the rated voltage which outputted from the battery pack 10 to the motor 21 is 19V and drives the motor 21 to run.

Reference to FIG. 4, when the required voltage of the motor 21 is 40V, connect the power tool 20 into the first interface′ 13′ of the battery pack 10, at this moment, the first positive terminal 12a connected to the second positive terminal 22a, the first negative terminal 12b connected to the second negative terminal 22b, the first positive terminal′ 12a′ connected to the second positive terminal′ 22a′, the first negative terminal′ 12b′ connected to the second negative terminal′ 22b′, the second negative terminal 22b connected to the second positive terminal′ 22a′, the second positive terminal 22a connected to the second negative terminal′ 22b′, so that the rated voltage which outputted from the battery pack 10 to the power tool 20 is 38V and drives the motor′ 21′ to run.

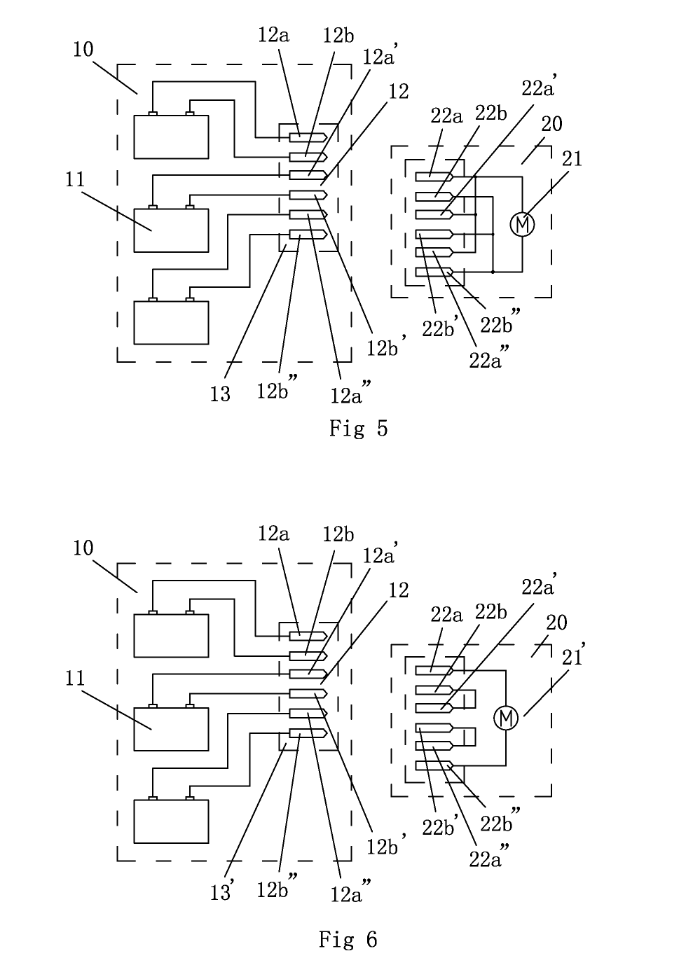

FIGS. 5 and 6 are circuit diagrams of further another preferred embodiment of the present patent application which composed three sets of battery. The battery pack 10 provided with a first interface 13 as well, the first connection terminal set 12 comprises a first positive terminal 12a, a first negative terminal 12b, a first positive terminal′ 12a′, a first negative terminal′ 12b′, a first positive terminal″ 12a″ and a first negative terminal″ 12b″. The first positive terminal 12a, the first negative terminal 12b, the first positive terminal′ 12a′, the first negative terminal′ 12b′, the first positive terminal″ 12a″ and the first negative terminal″ 12b″ located at the first interface 13, the second connection terminal set 22 comprises a second positive terminal 22a and a second negative terminal 22b which are correspondingly electrically connected to the first positive terminal 12a and the first negative terminal 12b, a second positive terminal′ 22a′ and a second negative terminal′ 22b′ which correspondingly electrically connected to the first positive terminal′ 12a′ and the first negative terminal′ 12b′, a second positive terminal″ 22a″ and a second negative terminal″ 22b″ which correspondingly electrically connected to the first positive terminal″ 12a″ and the first negative terminal″ 12b″. Therein, second positive terminal 22a, the second positive terminal′ 22a′ and the second positive terminal″ 22a″ electrically connected, the second negative terminal 22b, the second negative terminal′ 22b′ and the second negative terminal″ 22b″ electrically connected, so that three sets of battery cell are connected in parallel, and then the rated voltage which outputted from the battery pack 10 to the motor 21 is 19V; the second negative terminal 22b electrically connected to the second positive terminal′ 22a′, the second positive terminal″ 22a″ electrically connected to the second negative terminal′ 22b′, so that three sets of battery cell are connected in series, and then the rated voltage which outputted from the battery pack 10 to the motor 21 is 57V.

Reference to FIG. 5, when the required voltage of the motor 21 is 20V, connect the power tool 20 into the first interface 13 of the battery pack 10, at this moment, the first positive terminal 12a connected to the second positive terminal 22a, the first negative terminal 12b connected to the second negative terminal 22b, the first positive terminal′ 12a′ connected to the second positive terminal′ 22a′, the first negative terminal′ 12b′ connected to the second negative terminal′ 22b′, the first positive terminal″ 12a″ connected to the second positive terminal″ 22a″, the first negative terminal″ 12b″ connected to the second negative terminal″ 22b″, the second positive terminal 22a and the second positive terminal′ 22a′ electrically connected to the second positive terminal″ 22a″, the second negative terminal 22b and the second negative terminal′ 22b′ electrically connected to the second negative terminal″ 22b″, so that the rated voltage which outputted from the battery pack 10 to the motor 21 is 19V and drives the motor 21 to run.

Reference to FIG. 6, when the required voltage of the motor′ 21′ is 20V, connect the power tool 20 into the first interface 13′ of the battery pack 10, at this moment, the first positive terminal 12a connected to the second positive terminal 22a, the first negative terminal 12b connected to the second negative terminal 22b, the first positive terminal′ 12a′ connected to the second positive terminal′ 22a′, the first negative terminal′ 12b′ connected to the second negative terminal′ 22b′, the first positive terminal″ 12a″ connected to the second positive terminal″ 22a″, the first negative terminal″ 12b″ connected to the second negative terminal″ 22b″, the second negative terminal 22b electrically connected to the second positive terminal′ 22a′, the second positive terminal″ 22a″ electrically connected to the second negative terminal′ 22b′, so that the rated voltage which outputted from the battery pack 10 to the power tool 20 is 38V and drives the motor′ 21′ to run.

By effectively selecting the outputting voltage of the battery pack 10, in the condition of without adding additional electronic element, so that the unnecessary power consume of the electronic element avoided; besides, the battery pack of the present patent application may supply power to the electric devices which require different voltages so that it can be used on the electric devices with different rating voltages; the ability of universal application is very high and the manufacturing cost apparently reduced.

Of course, the number of the battery cell set could be four sets, five sets and even more.

With the hint of the above preferred embodiments, according to the foregoing detailed description of the patent application, those who are skilled in the art may make multiple alternations and modifications without bias the basic theory of the present patent application. The technical scope of the present patent application is not limited to the foregoing described content and it has to be defined according to the scope of the claims.

What is claimed is:

1. A battery pack, it outputs two volumes or more than two volumes of voltage or capacity.

2. Battery pack according to claim 1, wherein it comprising two sets or more than two sets of battery cells which connected to each other in series or in parallel so as to output two volumes or more than two volumes of voltage or capacity.

3. Battery pack according to claim 2, wherein the battery pack provided with a first terminal set which correspondingly electrically connected with the battery cells, the first terminal set provided with a transmission switch via which the two sets or more than two sets of battery cells connected in series or in parallel so as to output two volumes ore more than two volumes of voltage or capacity out.

4. Battery pack according to claim 1, wherein the battery pack used for connecting to a cordless power tool so as to supply voltage or capacity thereto.

5. Battery pack according to claim 3, wherein the first terminal set at least comprising a first positive terminal, a first negative terminal, a first positive terminal′ and a first negative terminal′, when two sets of battery cell or more than two sets of battery cell connected in parallel so as to output voltage or capacity, via shifting a transmission switch, the first positive terminal being electrically connected to the first positive terminal′, the first negative terminal being electrically connected to the first negative terminal′; when two sets of battery cell or more than two sets of battery cell connected in series so as to output voltage or capacity, via shifting the transmission switch, the first negative terminal being electrically connected to the first positive terminal′, the first positive terminal being electrically connected to the first negative terminal′.

6. Battery pack according to claim 3, wherein the transmission switch being work electronically or mechanically.

7. Battery pack according to claim 5, wherein the transmission switch being work electronically or mechanically.

8. A combination of a battery pack and an electrical device, comprising:
a battery pack, which comprising two sets or more than two sets of battery cell and a first terminal set that electrically connected to the battery cell sets;
a electrical device, which comprising a second connection terminal set that responses to the first connection terminal set so that two volumes or more than two volume of voltage or capacity outputted from the battery pack to the electrical device;
wherein when the working voltage of the electrical device being the voltage of a set of battery pack or being the plus of two sets or more than two sets of battery cell, the second connection terminal set of the electrical device connected to the first connection terminal set of the battery pack so as to connect two sets of battery cell or more than two sets of batteries in parallel;
when the working voltage of the electrical device being the plus of the voltage/capacity of two sets or more than two sets of battery cell, the second connection terminal set of the electrical device connected to the connection first terminal set of the battery pack so as to connect two sets of battery cell or more than two sets of batteries in series.

9. The combination of a battery pack and an electrical device of claim 8, wherein the first connection terminal set at least comprising a first positive terminal, a first negative terminal, a first positive terminal′ and a first negative terminal′, the second connection terminal set comprising a second positive terminal and a second negative terminal which are correspondingly connected to the first positive terminal and the first negative terminal, and a second positive terminal′ and a second negative terminal′ which are correspondingly connected to the first positive terminal′ and the first negative terminal′.

10. The combination of a battery pack and an electrical device of claim 8, wherein the electrical device is a cordless power tool.

11. The combination of a battery pack and an electrical device of claim 9, wherein when the working voltage of the electrical device being the voltage of a set of battery cell, the second positive terminal electrically connected to the second positive terminal′, the second negative terminal electrically connected to the second negative terminal′.

12. The combination of a battery pack and an electrical device of claim 9, wherein when the working voltage of the electrical device being the plus of two sets of battery cell or the plus of more than two sets of battery cell, the second negative terminal electrically connected to the second positive terminal′, the second positive terminal electrically connected to the second negative terminal′.
